(19) United States
(12) Patent Application Publication
(10) Pub. No.: US 2015/0095360 A1
(43) Pub. Date: Apr. 2, 2015

(54) MULTIVIEW PRUNING OF FEATURE DATABASE FOR OBJECT RECOGNITION SYSTEM

(71) Applicant: QUALCOMM Incorporated, San Diego, CA (US)

(72) Inventors: Bojan VRCELJ, San Diego, CA (US); Raghuraman KRISHNAMOORTHI, San Diego, CA (US); Qi PAN, Wien (AT); Wonwoo LEE, Vienna (AT); Emilio MAGGIO, Vienna (AT)

(21) Appl. No.: 14/492,976

(22) Filed: Sep. 22, 2014

Related U.S. Application Data
(60) Provisional application No. 61/883,736, filed on Sep. 27, 2013.

(51) Int. Cl. G06F 17/30

(52) U.S. Cl. CPC G06F 17/30386; G06F 17/30061; G06F 17/30259
USPC 707/758

(57) ABSTRACT

A method of building a database for an object recognition system includes acquiring several multi-view images of a target object and then extracting a first set of features from the images. One of these extracted features is then selected and a second set of features is determined based on which of the first set of features include both, descriptors that match and keypoint locations that are proximate to the selected feature. If a repeatability of the selected feature is greater than a repeatability threshold and if a discriminability is greater than a discriminability threshold, then at least one derived feature is stored to the database, where the derived single feature is representative of the second set of features.

### CROSS-REFERENCE TO RELATED APPLICATION

This application claims the benefit of U.S. Provisional Application No. 61/883,736, filed Sep. 27, 2013.

### TECHNICAL FIELD

This disclosure relates generally to computer vision based object recognition applications, and in particular but not exclusively, relates to building feature databases for such systems.

### BACKGROUND INFORMATION

A challenge to enabling Augmented Reality (AR) on mobile phones or other mobile platforms is the problem of detecting and tracking objects in real-time. Object detection for AR applications has very demanding requirements: it must deliver full six degrees of freedom, give absolute measurements with respect to a given coordinate system, be very robust and run in real-time. Of interest are methods to compute camera pose using computer vision (CV) based approaches, which rely on first detecting and, subsequently, tracking objects within the camera view. In one aspect, the detection operation includes detecting a set of features contained within the digital image. A feature may refer to a region in the digital image that differs in properties, such as brightness or color, compared to areas surrounding that region. In one aspect, a feature is a region of a digital image in which some properties are constant or vary within a prescribed range of values.

The detected features are then compared to known features contained in a feature database in order to determine whether a real-world object is present in the image. Thus, an important element in the operation of a vision-based AR system is the composition of the feature database. In some systems, the feature database is built pre-runtime by taking multiple sample images of known target objects from a variety of known viewpoints. Features are then extracted from these sample images and added to the feature database. However, storing every extracted feature results in prohibitively large databases which leads to poor performance.

### BRIEF SUMMARY

Some embodiments discussed herein provide a feature database for object recognition/detection that is generated by pruning similar features extracted from multi-view sample images of a known object. In general, features are extracted from multi-view images and then a derived feature that is representative of a group of similar features is then generated and stored in the database. The group of similar features may then be discarded (i.e., pruned). Thus, the database avoids the issue of containing similar features with an unmanageable database size. Accordingly, the derived features that are added to the database are not the extracted features, but instead are each derived from a group of like extracted features.

According to one aspect of the present disclosure, a method of building a database for an object recognition system includes acquiring several multi-view images of a target object and then extracting a first set of features from the images. In one example the first set of features is limited to only those features which correspond to the target object. Next, one of these extracted features is selected and a second set of features is determined based on the selected feature. In one example, the features included in the second set are taken from the first set of features and include those features that have both, a descriptor that matches (e.g., is similar) to the descriptor of the selected feature, and a keypoint location that is the same or proximate to the keypoint location of the selected feature. In one example, if a repeatability of the selected feature is greater than a repeatability threshold and if a discriminability is greater than a discriminability threshold, then at least one derived feature is stored to the database, where the derived feature is representative of the second set of features. The second set of features may then be discarded and the process repeated for each remaining feature included in the first set of extracted features.

According to another aspect of the present disclosure, a computer-readable medium including program code stored thereon is provided. The program code is configured to build a database containing a plurality of features corresponding to a 3-dimensional (3D) target object and includes instructions to acquire a plurality of images of the target object, where each of the plurality of images are acquired from a distinct and known viewpoint of the target object. The program code also includes instructions to extract a first set of features from the plurality of images, where each extracted feature includes a descriptor and a corresponding keypoint location. A feature is then selected from the first set of features and a series of instructions are performed on the selected feature. For example, a second set of features may be features chosen from the first set of features that have both, a descriptor that matches a descriptor of the selected feature, and a keypoint location proximate to a keypoint location of the selected feature. Next, a repeatability and discriminability of the selected feature is determined. A derived feature, representative of the entire second set is then stored based on the repeatability and discriminability of the selected feature.

In yet another aspect of the present disclosure an apparatus includes both memory and a processing unit. The memory is adapted to store program code for building a database containing a plurality of features corresponding to a 3-dimensional (3D) target object. The processing unit is coupled to the memory and adapted to access and execute instructions included in the program code. When the instructions are executed by the processing unit, the processing unit directs the apparatus to acquire a plurality of images of the target object, where each of the plurality of images are acquired from a distinct and known viewpoint of the target object. The processing unit also directs the apparatus to extract a first set of features from the plurality of images, where each extracted feature includes a descriptor and a corresponding keypoint location. The processing unit then selects a feature from the first set of features; and then, (a) determines a second set of features corresponding to the selected feature, wherein the second set of features includes features of the first set that have both, a descriptor that matches a descriptor of the selected feature, and a keypoint location proximate to a keypoint location of the selected feature; (b) determines a repeatability of the selected feature; (c) determines a discriminability of the selected feature; and (d) stores at least one derived feature based, at least, on the repeatability of the selected feature, a repeatability threshold, the discriminability of the selected feature, and a discriminability threshold, wherein the at least one derived feature is representative of the second set of features.

An apparatus according to another aspect of the present disclosure is for use in building a database containing a plurality of features corresponding to a 3-dimensional (3D) target object. The apparatus includes means for acquiring a plurality of images of the target object, where each of the plurality of images are acquired from a distinct and known viewpoint of the target object. The apparatus also includes means for extracting a first set of features from the plurality of images, where each extracted feature includes a descriptor and a corresponding keypoint location. Also included in the apparatus are means for selecting a feature from the first set of features, and then: (a) determining a second set of features corresponding to the selected feature, wherein the second set of features includes features of the first set that have both, a descriptor that matches a descriptor of the selected feature, and a keypoint location proximate to a keypoint location of the selected feature; (b) determining a repeatability of the selected feature; (c) determining a discriminability of the selected feature; and (d) storing at least one derived feature based, at least, on the repeatability of the selected feature, a repeatability threshold, the discriminability of the selected feature, and a discriminability threshold, wherein the at least one derived feature is representative of the second set of features.

The present disclosure also provides a method of building a pruned database from an existing model containing a first set of features. This method includes rendering several synthetic images of a target object. Features are then extracted from the synthetic images to create a second set of features. The extracted features of the second set are matched to features included in the first set. Then it is determined how many matches there are for each feature of the first set. The feature with the most matches is added to the pruned database and then removed from the first set. The feature from the first set with the next most matches is then added to the pruned database and so on, until each viewpoint used to render the synthetic images includes a threshold number of features that have been added to the pruned database.

In particular, building a pruned database from an existing database is accomplished by way of a computer-implemented method, where the existing database contains a first set of features corresponding to a target object. The method includes: rendering a plurality of synthetic images of the target object based on the first set of features contained in the existing database, wherein each of the plurality of synthetic images are rendered using a distinct and known viewpoint; extracting a second set of features from the plurality of synthetic images; matching features of the second set to features included in the first set; determining a number of times each feature of the first set is matched to a feature of the second set; and then, (a) adding a feature of the first set that has the most matches to the pruned database and removing the feature from the first set; and (b) repeating (a) until each viewpoint used to render the plurality of synthetic images includes a threshold number of features added to the pruned database.

According to several embodiments, the above computer-implemented method of building a pruned database from an existing database may further include:
repeating (a) until each viewpoint used to render the plurality of synthetic images includes the threshold number of features added to the pruned database or until there are no features left in the first set of features;
reducing an influence of those features remaining in the first set corresponding to a viewpoint if the threshold number of features corresponding to that viewpoint have been added to the pruned database;
the threshold number of features is a minimum number of matches needed to detect the target object from each viewpoint;
once each viewpoint used to render the plurality of synthetic images includes the threshold number of features added to the pruned database, then (c) calculating a detection probability gain of adding a feature to the pruned database for each feature remaining in the first set of features; (d) if at least one of the remaining features of the first set provides a detection probability gain larger than a probability gain threshold, then adding a feature of the first set with a highest detection probability gain to the pruned database and removing the feature with the highest detection probability gain from the first set; and (e) repeating (c)-(d) until a detection probability given by the pruned database is greater than a probability threshold.

In addition, according to several embodiments, the above computer-implemented method of building a pruned database from an existing database may by embodied by way of a computer-readable medium that includes program code stored thereon for building the pruned database. The program code may include instructions to: render a plurality of synthetic images of the target object based on the first set of features contained in the existing database, wherein each of the plurality of synthetic images are rendered using a distinct and known viewpoint; extract a second set of features from the plurality of synthetic images; match features of the second set to features included in the first set; determine a number of times each feature of the first set is matched to a feature of the second set; and then, (a) add a feature of the first set that has the most matches to the pruned database and removing the feature from the first set; and (b) repeat (a) until each viewpoint used to render the plurality of synthetic images includes a threshold number of features added to the pruned database.

According to several embodiments, the above computer-readable medium for building a pruned database from an existing database may further include:
instructions to repeat (a) until each viewpoint used to render the plurality of synthetic images includes the threshold number of features added to the pruned database or until there are no features left in the first set of features;
instructions to reduce an influence of those features remaining in the first set corresponding to a viewpoint if the threshold number of features corresponding to that viewpoint have been added to the pruned database;
the threshold number of features is a minimum number of matches needed to detect the target object from each viewpoint;
once each viewpoint used to render the plurality of synthetic images includes the threshold number of features added to the pruned database, then: (c) calculate a detection probability gain of adding a feature to the pruned database for each feature remaining in the first set of features; (d) if at least one of the remaining features of the first set provides a detection probability gain larger than a probability gain threshold, then add a feature of the first set with a highest detection probability gain to the pruned database and remove the feature with the highest detection probability gain from the first set; and (e) repeating (c)-(d) until a detection probability given by the pruned database is greater than a probability threshold;

Furthermore, the present disclosure further provides for an apparatus that includes memory and a processing unit. The memory is adapted to store program code for building a pruned database from an existing database containing a plurality of features corresponding to a target object. The processing unit is adapted to access and execute instructions included in the program code, wherein when the instructions are executed by the processing unit, the processing unit directs the apparatus to: render a plurality of synthetic images of the target object based on the first set of features contained in the existing database, wherein each of the plurality of synthetic images are rendered using a distinct and known viewpoint; extract a second set of features from the plurality of synthetic images; match features of the second set to features included in the first set; determine a number of times each feature of the first set is matched to a feature of the second set; and then, (a) add a feature of the first set that has the most matches to the pruned database and removing the feature from the first set; and (b) repeat (a) until each viewpoint used to render the plurality of synthetic images includes a threshold number of features added to the pruned database.

According to several embodiments, the above apparatus may further include:
instructions to repeat (a) until each viewpoint used to render the plurality of synthetic images includes the threshold number of features added to the pruned database or until there are no features left in the first set of features;
instructions to direct the apparatus to reduce an influence of those features remaining in the first set corresponding to a viewpoint if the threshold number of features corresponding to that viewpoint have been added to the pruned database;
the threshold number of features is a minimum number of matches needed to detect the target object from each viewpoint;
instructions to direct the apparatus to, once each viewpoint used to render the plurality of synthetic images includes the threshold number of features added to the pruned database, then (c) calculate a detection probability gain of adding a feature to the pruned database for each feature remaining in the first set of features; (d) if at least one of the remaining features of the first set provides a detection probability gain larger than a probability gain threshold, then add a feature of the first set with a highest detection probability gain to the pruned database and remove the feature with the highest detection probability gain from the first set; and (e) repeat (c)-(d) until a detection probability given by the pruned database is greater than a probability threshold.

The above and other aspects, objects, and features of the present disclosure will become apparent from the following description of various embodiments, given in conjunction with the accompanying drawings.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a flowchart illustrating a process of building a database containing a plurality of derived features.

FIG. 2 is a functional block diagram of a processing unit for building a database containing a plurality of derived features.

FIG. 3 is a diagram illustrating the capturing of several images from distinct viewpoints and the subsequent extraction of a set of features.

FIG. 4 is a functional block diagram illustrating an apparatus capable of performing the processes discussed herein.

FIG. 5 is a flowchart illustrating a process of building a pruned database from an existing database.

FIG. 6 is flowchart illustrating a process of probabilistic pruning for building a pruned database from an existing database.

FIG. 7 is a diagram illustrating the rendering of several synthetic images having distinct viewpoints and the subsequent extraction of a set of features.

FIG. 8 is a functional block diagram of a processing unit for pruning of an existing database.

FIG. 9 is a functional block diagram of an object recognition system.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

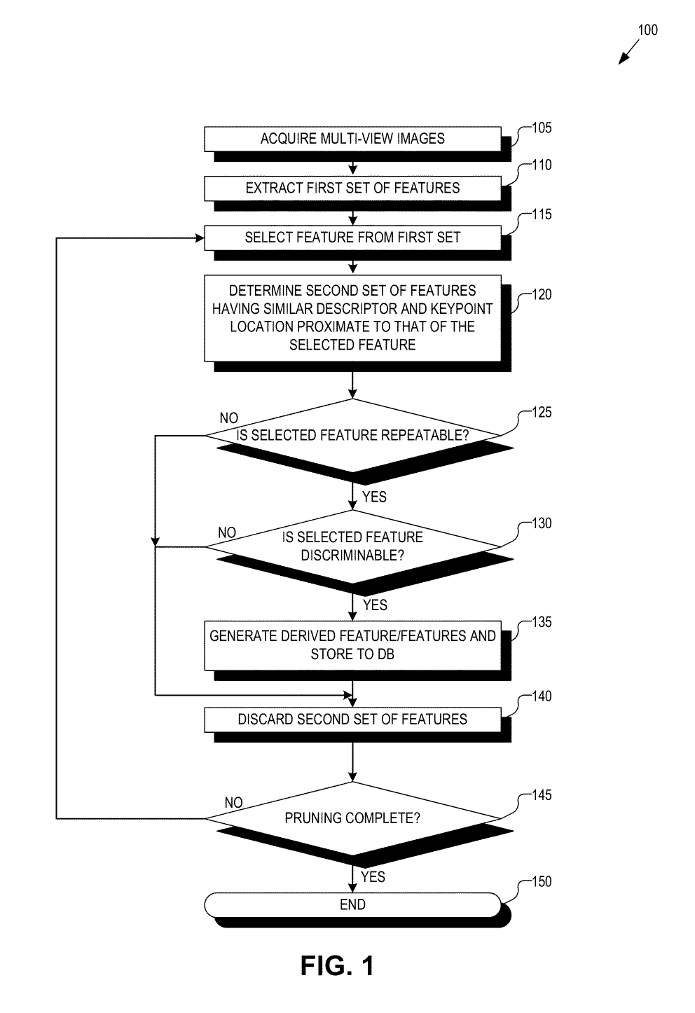

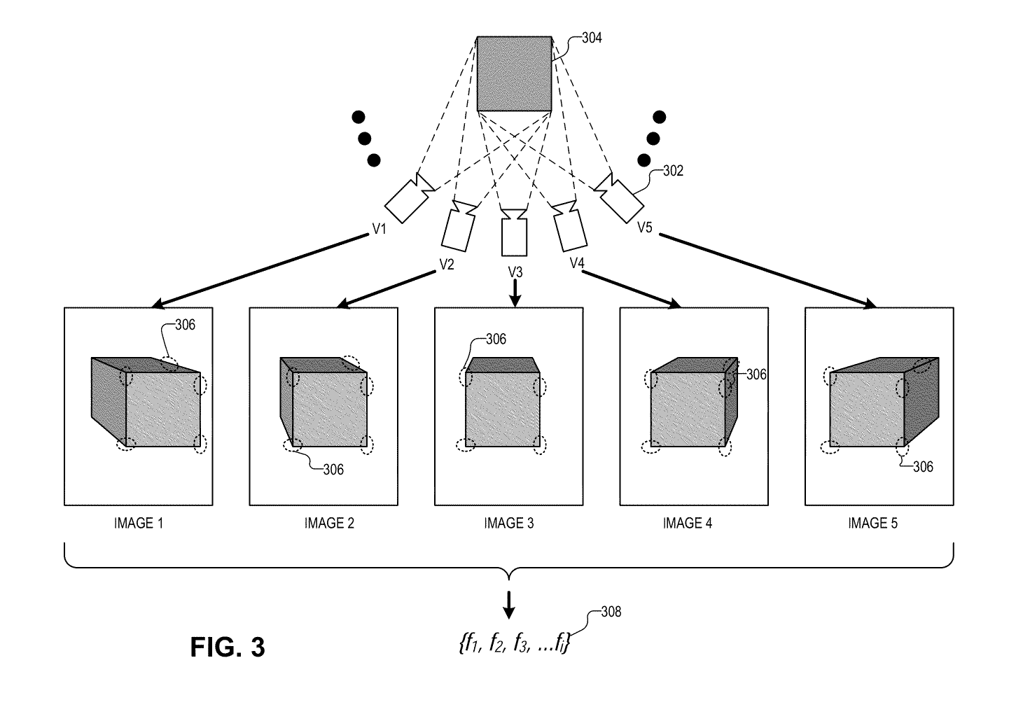

FIG. 1 is a flowchart illustrating a process 100 of building a database containing a plurality of derived features. As shown, process 100 includes first acquiring several images of a known 3D real-world target object. Each image acquired may be taken from a distinct and known viewpoint of the target object. For example, FIG. 3 illustrates a camera 302 capturing several images (e.g., images 1-5) of a target object 304 from several distinct viewpoints (e.g., V1-V5). Although, FIG. 3 only illustrates five sample images taken from five distinct viewpoints, embodiments of the present disclosure may include capturing many more sample images of target object 304. For example, sampling may be done by systematically moving the camera about concentric spheres pointing towards the center, around the target object 304. In some sampling examples, various positional attributes of the camera may be varied, such as distance, pitch, and yaw. By way of example, a first set of sampling images is captured while performing 36 rotations of the target object at a first distance, a first pitch, and a first yaw. The next set of sampling images is captured from a second distance, but at the same first pitch and same first yaw. This may be repeated for several distances, keeping the pitch and yaw the same. Then, sampling images may be captured while performing 36 rotations of the target object from the first distance again, but at a different second pitch. Sampling images are then captured from the various distances and using this different second pitch. The result is a dense sampling of the target object having numerous sample images from differing viewpoints. However, as will be discussed below, oversampling is not an issue for embodiments discussed herein because of the feature pruning. Thus, embodiments of the disclosed feature database may be built based on sample images taken from an exhaustive number of views of the target object. Also, although FIG. 3 illustrates a single target object, in some embodiments images may be acquired of multiple target objects, such that the resultant database is a multi-object database containing derived features of multiple target objects.

Returning now to FIG. 1, process 100 next includes extracting a first set of features from the sample images (i.e., process block 110). In one example, feature extraction includes applying a Laplacian of Gaussian (LoG) or a Difference of Gaussians (DoG) based feature detector, such as the Scale Invariant Feature Transform (SIFT) algorithm, to each image in order to extract a first set of features. To be clear, the first set of features includes features extracted from all of the sampled images. By way of example, FIG. 3 illustrates a first set of features 308 that includes each of the features 306 extracted from the sample images 1-5. A feature, as used herein, may include a point of interest or “keypoint location” and a “descriptor” of the region surrounding the interest point.

In some embodiments, the first set of features (e.g., feature set 308) includes only those extracted features that have keypoint locations associated with the target object. For example, all features in the first set may be limited to such features that belong to the object of interest. This determination may be done by using a CAD model corresponding to the target object and the known camera pose to segment out the features belonging to the object. Alternative solutions are possible which include a measured depth of extracted features and a known camera pose, or alternative object segmentation techniques based on known background properties.

Once the first set of features is extracted, process block 115 includes selecting one of the features from the first set. Next, in process block 120, a second set of features is determined based on this selected feature. For example, process block 120 may include examining the first set of features to find those features that include both a descriptor that is similar to that of the selected feature and a keypoint locations that is proximate to that of the selected feature. These matched features are then added to the second set of features.

In one embodiment a descriptor is a L-dimensional vector describing the occurrence of a keypoint from one viewpoint (image). Thus, two descriptors are similar if their difference (which itself is a L-dimensional vector) is small in norm/magnitude. Accordingly, process block 120 may include determining whether two descriptors are similar by subtracting one descriptor from another and comparing the result to a descriptor distance threshold (e.g., |f₁−fᵢ|<descₜₕ, where descₜₕ is the descriptor distance threshold). Determining whether keypoint locations are proximate is similar to that describe above, except that keypoint locations are 3-dimensional vectors of (x,y,z) coordinates according to a pre-defined (or set) coordinate system (e.g., |k₁−kᵢ|<dkptₜₕ, where dkptₜₕ is the keypoint distance threshold).

Accordingly, the second set of features is a subset of the extracted first set of features whose descriptors are similar to that of the selected feature and also whose keypoint locations are proximate to that of the selected feature. In one embodiment, the second set of features includes the selected feature. Once this second set of features is determined, decision blocks 125 and 130, decide whether the selected feature is both repeatable and discriminable. The repeatability of a feature refers to the number of viewpoints in which the same (or similar) feature is observed and in one example, may just simply be the number of features included in the second set of features since each image was taken from a distinct viewpoint. In one embodiment, determining the repeatability of the selected feature includes determining whether a keypoint location of the selected feature is observable from multiple distinct viewpoints, and if so determining a number of viewpoints in which the keypoint location of the selected feature is described by a descriptor similar to the descriptor of the selected feature. It is noted that this determination of the number of viewpoints includes analysis of the selected feature's keypoint location, as well as proximally located keypoints (e.g., within the keypoint distance threshold dkptₜₕ). Thus, the repeatability may be determined by counting the number of similar observations of a same or proximally located keypoint. In other words, similar descriptors attached to keypoints that are distinct but essentially co-located count as two observations of a same keypoint. Once quantified, the repeatability of the selected feature may then be compared against a fixed repeatability threshold (rᵢ>rₜₕ?).

The discriminability of the features refers to the ability to discriminate between the selected feature and other extracted features. In one example, the discriminability may be quantified as the ratio of the number of features in the second set to the number of all extracted features that have similar descriptors. Determining the discriminability of the selected feature may include determining a first number of viewpoints in which a keypoint location of the selected feature (or proximally located keypoints) is described by a descriptor similar to a descriptor of the selected feature. Then a second number of all features in the first set of features that have descriptors similar to the descriptor of the selected feature, regardless of keypoint location, is determined. The discriminability may then be represented as the ratio between this first number to the second number. In one embodiment, the discriminability is compared against a fixed discriminability threshold to determine whether the discriminability of the selected feature is high enough (dᵢ>dₜₕ?).

If, in decision block 130, it is determined that the selected feature is not discriminable (e.g., dᵢ<dₜₕ) then this indicates that the features from the second set are not to be represented in the pruned database due to low discriminability. That is, besides a cluster of similar descriptors at a keypoint location, the first set of features contains at least one more similar descriptor of a different keypoint location. In the matching process an observation of this keypoint may then easily be mistaken by an observation of another keypoint, and vice versa. Thus, the features of the second set as well as the features in the first set that have a similar descriptor may be discarded (e.g., process block 140) as they are not consistent with a unique geometric location. In one embodiment, these discarded features may still figure in calculating the discriminability of other unrelated features, but by the symmetric nature of “similarity” relationships and by the fact that the descriptors in the second set of features are by nature grouped tightly together, all these features are safe to ignore from that point onwards.

If, in decision block 125, it is determined that the selected feature is not repeatable (e.g., rᵢ<rₜₕ), then this indicates that the features from the second set are not to be represented in the pruned database due to low repeatability. Thus, the same low repeatability will hold true not just for the selected feature, but for all the features in the second set. Thus, none of them should be represented in the pruned database. Moreover, if a keypoint location is genuinely so hard to observe, then these descriptors need not penalize other similar descriptors attached to a more repeatable different keypoint by casting them to be not discriminative. Therefore, again, for all practical purposes, it is safe to simply discard all features in the second set (e.g., process block 140) from that point onward.

If, however, the second set of features is determined to be both repeatable and discriminable, then process 100 proceeds to process block 135, where at least one derived feature is generated and added to the feature database. The derived feature is representative of the second set of features and, in one example, may include a descriptor that is an average of the descriptors included in the second set.

In one example, the derived feature is a single feature representative of all the features included in the second set. In another example, process block 135 includes generating an M number of derived features for the selected feature, where the M number of derived features are generated by clustering together features of the second set into M number of clusters and then taking cluster centers.

Once the derived feature(s) is added to the database, the features of the second set may then be discarded (i.e., process block 140). In one embodiment, discarding features includes removing them from the first set of extracted features.

Next, in decision block 145 it is determined whether pruning is complete. In one example, pruning may be deemed as complete if all features of the first set have been processed by the pruning process 100. If pruning is done then process 100 completes (150). If pruning is not complete, process 100 returns to process block 115 to select another feature from the first set (e.g., fᵢ₊₁) to examine for feature pruning.

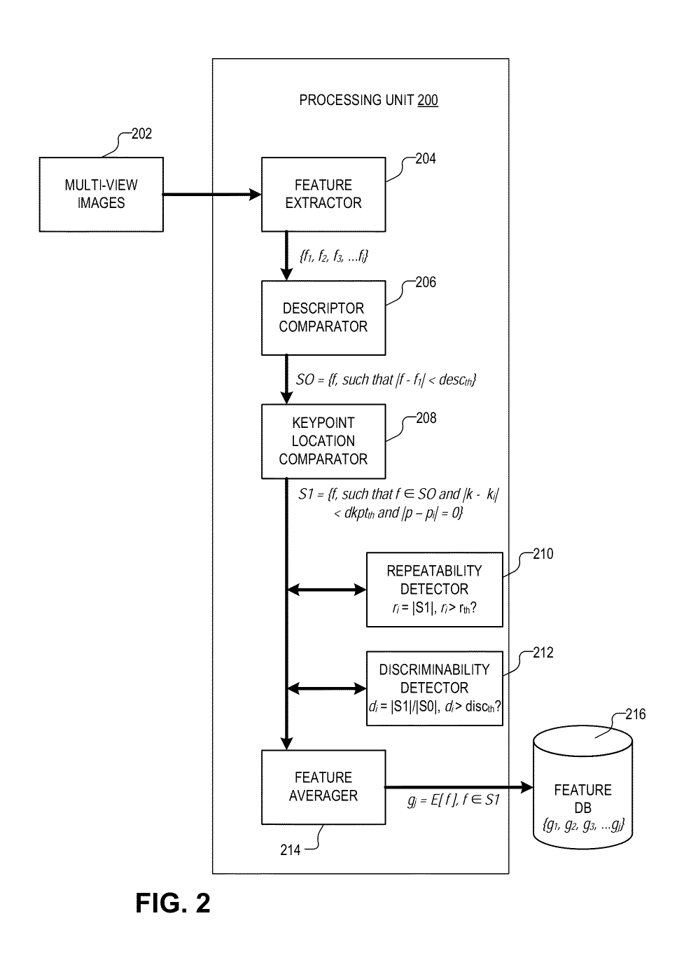

FIG. 2 is a functional block diagram of a processing unit 200 for building a database 216 containing a plurality of derived features {g₁, g₂, g₃, . . . gⱼ}. In one embodiment, processing unit 200, under direction of program code, may perform process 100, discussed above. For example, as shown, multi-view images 202 are provided to be processed. Images 202 may be uploaded as a set of images to the server (or several servers) prior to creating the database 216, as well as individually by a device such as a mobile platform. As mentioned previously, images 202 should be representative of several distinct and known viewpoints. Feature extractor 206 then extracts a set of features by using any known feature extraction technique, such as SIFT, SURF, GLOH, CHoG, or other comparable techniques. As discussed above, the set of features {f₁, f₂, f₃, . . . , fᵢ} may be limited to those features that belong to the target object. Next, descriptor comparator 206 selects one feature and finds features within the set of extracted features that have descriptors that are similar to that of the selected feature. Descriptor comparator 206 generates a set of features S0 that is a subset of the extracted features. As shown, set S0 may be defined as: S0={f, such that |f−f1|<descₜₕ}, where descₜₕ is the descriptor distance threshold. Keypoint location comparator 208 then takes the set S0 and determines which of those features have keypoint locations that are proximate to that of the selected feature. Keypoint location comparator 208 generates a set of features S1 that is a subset of set S0, and may be defined as: S1={f, such that fεS0 and |k−kᵢ|<dkptₜₕ and |p−pᵢ|=0}, where dkptₜₕ is the keypoint distance threshold. The output of keypoint location comparator 208 is the feature set S1, which includes extracted features that have both descriptors that are similar and keypoint locations that are proximate to that of the selected feature.

Next, repeatability detector 210 examines the feature set S1 and determines whether the selected feature is repeatable. In one example, the repeatability of the selected feature is quantified as rᵢ and may simply be the number of features included in the feature set S1. The more features included in feature set S1 corresponds to a larger number of viewpoints in which the keypoint location of the selected feature (or keypoint locations proximate to the keypoint location of the selected feature) is described by a descriptor similar to that of the selected feature. The more views that similar descriptors of a keypoint location (or proximate keypoint) appear means that the selected feature is more repeatable. Thus, the higher the repeatability rᵢ, the better. In one example, the repeatability rᵢ of the selected feature is compared against a repeatability threshold rₜₕ in order to determine whether the repeatability is high enough. In one embodiment, the repeatability threshold rₜₕ is fixed, however in other embodiment the repeatability threshold may vary based, for example, on the number of distinct viewpoints from which the images were acquired. By way of further example, the repeatability threshold may be directly related (e.g., proportional, a percentage, etc.) to the number of distinct viewpoints, such that as the number of viewpoints increases so too does the repeatability threshold.

Discriminability detector 212 also examines the feature set S1 and determines whether the selected feature is discriminable. That is, discriminability may refer to how easy is it to notice and understand that the selected feature is different from other extracted features. In one example, the discriminability of the selected feature is quantified as dᵢ and may be equal to a ratio of the number of features in set S1 to the number of features in set S0 (i.e., dᵢ=|S1|/|S0|). The higher the discriminability, the easier it is to discriminate the selected feature from other extracted features. In one example, discriminability dᵢ is compared against a discriminability threshold discₜₕ in order to determine whether the discriminability of the selected feature is high enough. Ideally, the discriminability dᵢ is equal to 1.0 (i.e., all of the extracted features with similar descriptors have proximate keypoint locations). In one embodiment, the discriminability threshold discₜₕ is fixed at about 0.75.

If the repeatability detector 210 determines that the repeatability of the selected feature is high enough and if the discriminability detector 212 determines that the discriminability of the selected feature high enough, then feature averager 214 may proceed with generating a derived feature gᵢ (or M clusters of features) that is representative of the entire feature set S1. In one example, derived feature gᵢ includes a descriptor that is the average of the descriptors included in feature set S1. Next, the derived feature gᵢ is written to feature database 216. Optionally, the features included in set S1 may then be discarded and the process repeated for the remaining extracted features.

As shown, feature database 216 includes a j number of derived features gⱼ, while i number of features fᵢ were extracted by the feature extractor 204. Since each derived feature gⱼ is representative of a set of like extracted features, the number of derived features gⱼ added to the feature database 216 may be much less than the total number of extracted features fᵢ(e.g., j<<i). In one embodiment, the number of derived features added to database 216 may be orders of magnitudes less than the number of extracted features included in the first set. Accordingly, embodiments of building a pruned feature database 216 may avoid the issue of exceedingly large database sizes, while also providing a model of a target object from many, if not an exhaustive, number of viewpoints.

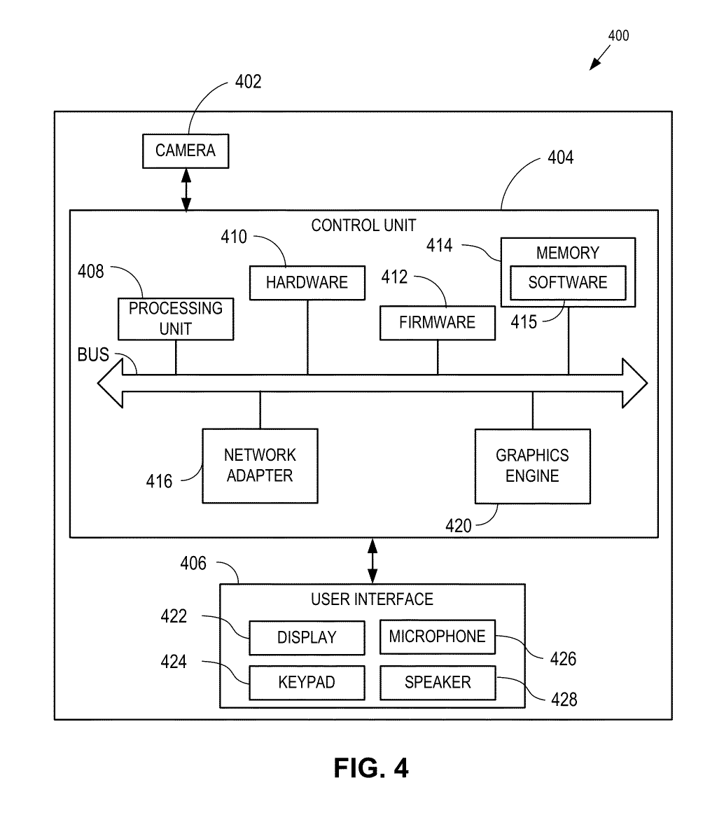

FIG. 4 is a functional block diagram illustrating an apparatus 400 capable of performing the processes discussed herein. In one embodiment apparatus 400 is a computer capable of building a pruned feature database, such as feature database 216 of FIG. 2. Apparatus 400 may optionally include a camera 402 as well as an optional user interface 406 that includes the display 422 capable of displaying images captured by the camera 402. User interface 406 may also include a keypad 424 or other input device through which the user can input information into the apparatus 400. If desired, the keypad 424 may be obviated by integrating a virtual keypad into the display 422 with a touch sensor. User interface 406 may also include a microphone 426 and speaker 428.

Apparatus 400 also includes a control unit 404 that is connected to and communicates with the camera 402 and user interface 406, if present. The control unit 404 accepts and processes images received from the camera 402 and/or from network adapter 416. Control unit 404 may be provided by a processing unit 408 and associated memory 414, hardware 410, software 415, and firmware 412.

Processing unit 200 of FIG. 2 is one possible implementation of processing unit 408 for building of a pruned database for use in an object recognition system, as discussed above. Control unit 404 may further include a graphics engine 420, which may be, e.g., a gaming engine, to render desired data in the display 422, if desired. Processing unit 408 and graphics engine 420 are illustrated separately for clarity, but may be a single unit and/or implemented in the processing unit 408 based on instructions in the software 415 which is run in the processing unit 408. Processing unit 408, as well as the graphics engine 420 can, but need not necessarily include, one or more microprocessors, embedded processors, controllers, application specific integrated circuits (ASICs), digital signal processors (DSPs), and the like. The terms processor and processing unit describes the functions implemented by the system rather than specific hardware. Moreover, as used herein the term “memory” refers to any type of computer storage medium, including long term, short term, or other memory associated with apparatus 400, and is not to be limited to any particular type of memory or number of memories, or type of media upon which memory is stored.

The processes described herein may be implemented by various means depending upon the application. For example, these processes may be implemented in hardware 410, firmware 412, software 415, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the processes may be implemented with modules (e.g., procedures, functions, and so on) that perform the functions described herein. Any computer-readable medium tangibly embodying instructions may be used in implementing the processes described herein. For example, program code may be stored in memory 415 and executed by the processing unit 408. Memory may be implemented within or external to the processing unit 408.

If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, Flash Memory, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As discussed above, an object recognition system includes capturing an image of a target object and then extracting features from this image. These extracted features are then compared against a feature database containing previously extracted features of known objects in order to produce reliable matches. However, the detection performance of different features of an object is not the same. For example, some physical object points can be reliably detected from wider viewing angles, which often depends on the surrounding texture and on the shape of the object itself. In addition, feature descriptor variations across different viewing angles can depend on local texture variations and on the object shape. Accordingly, embodiments of the present disclosure further provide a process of improving object detection speed and robustness by generating a feature database containing only those features that can significantly contribute to the detection task.

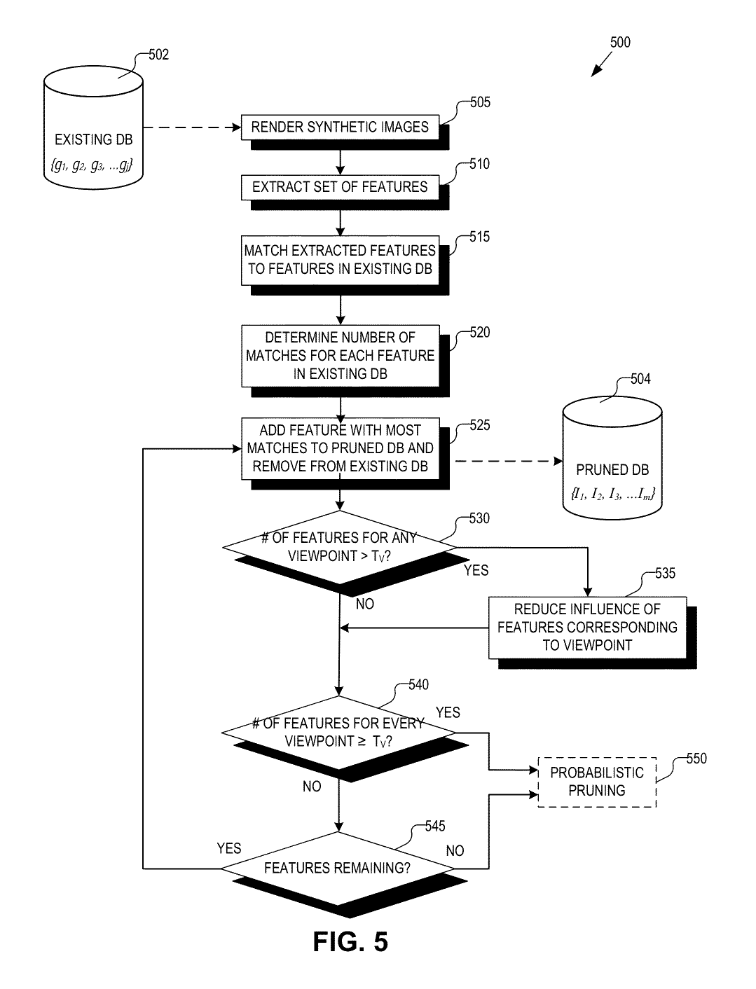

Given a camera frame, most pose estimation algorithms succeed if they can find a number of good matches above a predefined threshold T_{V}. In one embodiment, the threshold T_{V} is four (4). However, in another embodiment, the threshold T_{V} is ten (10). In yet another embodiment, the threshold T_{V} is fifteen (15). Thus, one aim of the pruning method described infra is to select a reduced feature set that gives at least T_{V} matches for all synthetic views. This in turn should improve the probability that a target is detectable from any real view. For example, FIG. 5 is a flowchart illustrating a process 500 of building a pruned database 504 from an existing database 502. Existing database 502 may include any feature database that includes features extracted from one or more sample images. In one embodiment, existing database 502 includes database 216 of FIG. 2.

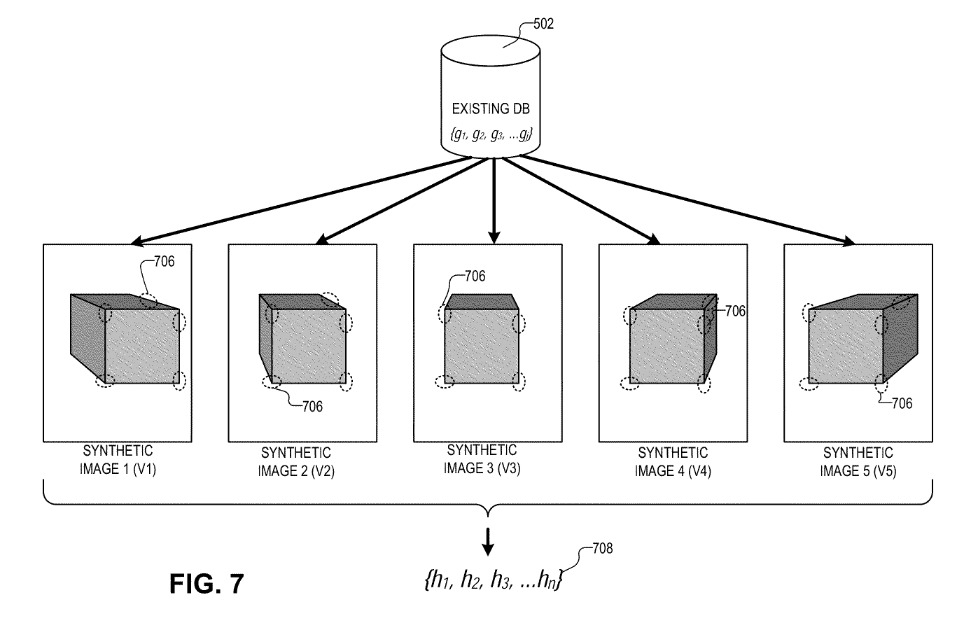

As shown, process 500 includes first rendering several synthetic (i.e., virtual) images of a target object based on the features contained in existing database 502 (i.e., process block 505). Each synthetic image generated may be rendered from a distinct and known viewpoint of the target object. For example, FIG. 7 illustrates several synthetic images (e.g., images 1-5) of a target object rendered at several distinct viewpoints (e.g., V1-V5). Although, FIG. 7 only illustrates five synthetic images rendered from five distinct viewpoints, embodiments of the present disclosure may include rendering many more synthetic images of a target object using the features gⱼ contained in the existing database 502. For example, rendering may be done by systematically moving the virtual camera about concentric spheres pointing towards the center, around the target object. In another embodiment, images are rendered representing only those viewpoints that a user is likely to encounter in the real world (e.g., unlikely to view the bottom of a teapot, so this viewpoint may be omitted).

Returning now to FIG. 5, process 500 next includes extracting a set of features from the synthetic images (i.e., process block 510). In one example, feature extraction includes applying a Laplacian of Gaussian (LoG) or a Difference of Gaussians (DoG) based feature detector, such as the Scale Invariant Feature Transform (SIFT) algorithm, to each image in order to extract a set of features. The set of features includes features extracted from all of the synthetic images. By way of example, FIG. 7 illustrates a set of features 708 that includes each of the features 706 extracted from the synthetic images 1-5.

Once the features are extracted, process block 515 includes matching the extracted features of process block 510 to those features contained in the existing database 502. In one embodiment, features are matched similar to that described above using descriptor distance (e.g., f−fᵢ<descₜₕ). Next, information on the relative pose between the virtual camera and the target object may be used to geometrically verify each match and discard false matches. By way of example, given a known 3D position of an object point in the object-centric coordinate system and given the camera pose, a point can be projected the camera image in a 2D coordinate system. Then if the 2D projection is within a fixed radius of the matched feature the match is kept, otherwise it is discarded.

Next, in process block 520 it is determined how many extracted features match to each feature contained in the existing database 502. That is, a first count may be maintained for each feature in existing database 502 indicating how many times an extracted feature is found that matches that feature in the database 502.

Next, in process block 525, the feature of existing database 502 that has the most matches is added to the pruned database 504. The feature with the most matches represents a feature that appears in the largest number of viewpoints and thus, is likely to aide in the object detection process. Also, in process block 525, the feature that was just added to the pruned database 504 (i.e., the feature with the most matches) is removed from the existing database 502.

Process 500 also includes maintaining a second count that represents the number of matches for each rendered viewpoint (e.g., V1-V5) generated by features that have been added to the pruned database 504. Thus, as a feature is added to the pruned database 504, the second count for each viewpoint associated with that feature is incremented.

Next, in decision block 530, if the second count for any viewpoint exceeds the threshold Tv, then process block 535 reduces the influence of all subsequent feature matches corresponding to that viewpoint. In one example, reducing the influence of the matches corresponding to a viewpoint may be done by simply decrementing the first count corresponding with those features that have a match in the viewpoint. If, in decision block 540, the count for each of the viewpoints is greater than or equal to the threshold Tv, then process 500 may proceed to optional process block 550 (discussed in more detail below). That is, a second count exceeding the threshold Tv for each viewpoint means that a sufficient number of features have been added to the pruned database 504 to allow detection of the target object from each viewpoint, such that no additional features need to be added to the pruned database 504.

However, if, in decision block 540, not all viewpoints meet the threshold Tv number of matches with the features currently added to the pruned database 504, then process 500 proceeds to process block 545 which determines whether there are any features remaining in the existing database 502. Process 500 then returns to process block 525 where the feature with the next highest number of matches is added to the pruned database 504. Thus, in summary, process 500 is an iterative process that includes taking a feature from the existing database 502 that has the next most matches and adding that feature to the pruned database 504. The taking of the feature with the next most matches and adding it to the pruned database repeats until each viewpoint used to render the synthetic images has a threshold number Tv of matches generated by features that have been added to the pruned database.

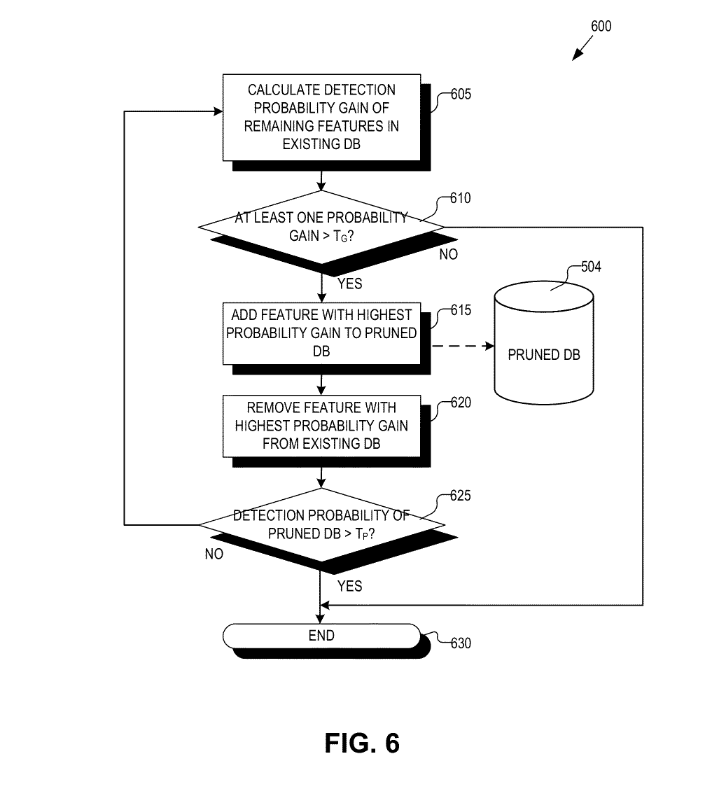

Given better knowledge of the pose estimation algorithm it is possible to further enhance the pruning process 500 described above, by using probability theory. Thus, process 500 includes an optional process block 550 of performing probabilistic pruning of the pruned database 504. For example, FIG. 6 is flowchart illustrating a process 600 of probabilistic pruning for further building the pruned database 504.

As shown in FIG. 6, process 600 first includes calculating a detection probability gain of those features remaining in the existing database 502 after completion of the pruning process 500 described above. If none of the remaining features provides a probability gain that is larger than at least a probability gain threshold T_{g}, then decision block 610 directs process 600 to end 630. If however, there is at least one feature remaining in the existing database 502 having a probability gain greater than the probability gain threshold T_{g}, then process 600 may proceed to process block 615, where the feature with the highest probability gain is added to the pruned database 504. Process block 620 then removes this feature (i.e., the feature with the highest probability gain) from the existing database 502.

In one embodiment, RANdom SAmple Consensus (RANSAC) algorithm is used to estimate the target pose from a set of matches. In this embodiment, the detection probability P_{d} can be computed as follows. RANSAC estimates the target pose from a minimal set of d points, typically d=3 or 4, which are randomly selected from the matches and then checks the consensus of the remaining matches with the candidate pose. For RANSAC to succeed the d matches must all be inliers (i.e., good matches). Assuming that v matches out of m matches extracted from an image are inliers, the probability of randomly picking an inlier from the set is Pᵢₙ(v,m)=v/m. Thus, the probability of failure for a set of d points is P_{DF}=1−(Pᵢₙ)^{d}. From this follows that the probability of success over k iterations is P_{S}=1−(P_{DF})^{k}. Finally, taking into account multiple n views and the minimum match count threshold T_{V} we can compute the overall detection probability as:

$${P}_{d} = \frac{1}{n} {\sum }_{i = 1}^{n} delta ( {v}^{i} , {T}_{V} ) {P}_{S}^{i} ( {v}^{i} ) , \\ delta ( x , T ) = \{ \begin{matrix}0 , & x < T \\ 1 , & otherwise\end{matrix} \} \qquad EQ . 1$$

The detection probability gain for a feature is the increase in detection probability obtained by adding a feature to the pruned database.

Next, in decision block 625, a detection probability given by the pruned database 504 is calculated. If the detection probability given by the pruned database 504 is greater than a probability threshold Tₚ, or if there are no features remaining in the existing database 502, then process ends at 630. Otherwise, process 600 returns to process block 605 to again calculate the detection probability gain of those features remaining in the existing database 502.

In another embodiment, the same probabilistic framework of FIG. 6 can be used to add robustness to partial occlusions. That is, the probability of detection over simulated occlusions data may be estimated. In this embodiment, the target area is divided into p×q cells. For example, an image target can be divided by 3×3 cells. Then a set of occlusion scenarios are defined where some cells are marked as visible while other cells as occluded. For each occlusion scenario we can compute the probability of detection using matches from visible cells only. In this embodiment, the probabilistic pruning process is the same as probabilistic pruning process 600, discussed above. However, instead of computing the probability gain for each feature addition from the non-occluded scenario only; a probability gain that combines scores from both non-occluded and occluded scenarios is used.

In yet another embodiment, a feature pruning process includes increasing performance under different illumination conditions. In particular, matching performance may significantly degrade in low-lighting scenarios. Low-lighting conditions result in a lower number of detected key-points, and in a reduction of the overall number of matches (inliers+outliers). Accordingly, this embodiment may include simulating low-lighting conditions by applying a higher threshold to cornerness scores used during key-point detection. Then, similar to the occlusion scenarios (see above), we compute the detection probability gain for each feature in low lighting scenarios. Selection of the best feature to add to the pruned database may then be based on a probability gain that is a combination of lighting, occluded and non-occluded scenario gains.

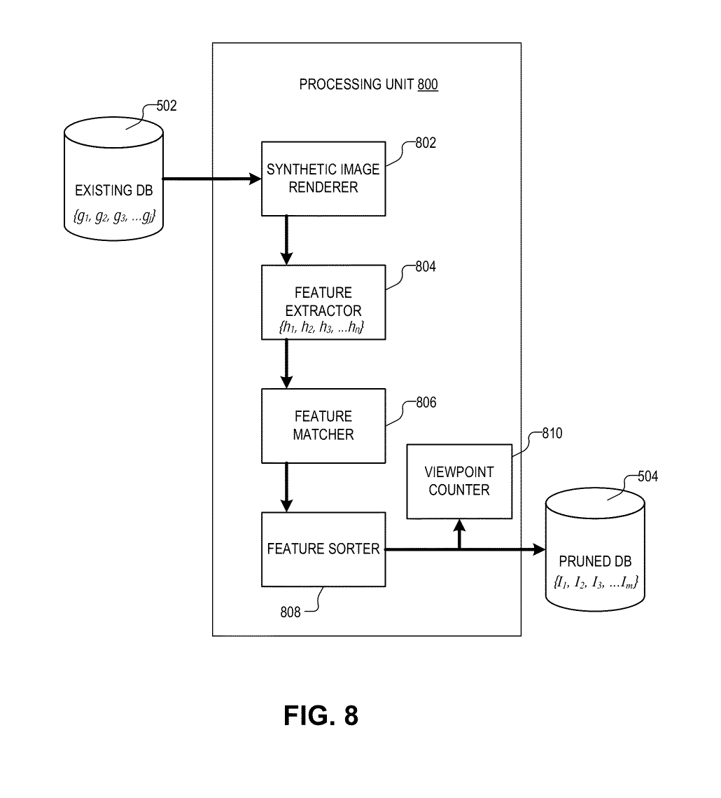

FIG. 8 is a functional block diagram of a processing unit 800 for pruning of an existing database 502. Processing unit 800 is one possible implementation of processing unit 408 of FIG. 4. In one embodiment, processing unit 200, under direction of program code, may perform process 500, discussed above. For example, as shown, multiple features are provided from an existing database 502 to be processed. Synthetic image renderer 802 then renders a set of synthetic images of the object target (e.g., synthetic images 1-5 of FIG. 7). As mentioned previously, the synthetic images should be representative of several distinct and known viewpoints, for example viewpoints expected to be encountered in a real-world scenario. Feature extractor 804 then extracts a set of features {h₁, h₂, h₃, . . . , hₙ} by using any known feature extraction technique, such as SIFT, SURF, GLOH, CHoG, or other comparable techniques. Next, feature matcher 806 matches the extracted features {h₁, h₂, h₃, . . . , hₙ} to the features included in the existing database 502 {g₁, g₂, g₃, . . . , gⱼ}. Feature sorter 808 then sorts the features in the existing database 502 based on each feature's number of matches. The feature with the largest number of matches may then be removed from the existing database 502 and added to the pruned database 504. Processing unit 800 may then continue by taking a feature from the existing database 502 that has the next most matches and adding that feature to the pruned database 504. Processing unit 800 may continue this process of taking of the features with the next most matches and adding them to the pruned database until each viewpoint used to render the synthetic images has a threshold number of matches generated by features that have been added to the pruned database, as indicated and controlled by viewpoint counter 810.

As shown, pruned database 504 includes a m number of features Iₘ, while j number of features gⱼ were included in the existing database 502. Since only those features that are determined to sufficiently aide in object detection are added to the pruned database 504, the number of features Iₘ, added to the pruned database 504 may be much less than the total number of features gⱼ included in the existing database 502 (e.g., m<<j). Accordingly, embodiments of pruning an existing database to build a pruned database may avoid the issue of exceedingly large database sizes, while also providing a model of a target object that includes only features that can significantly contribute to the detection process.

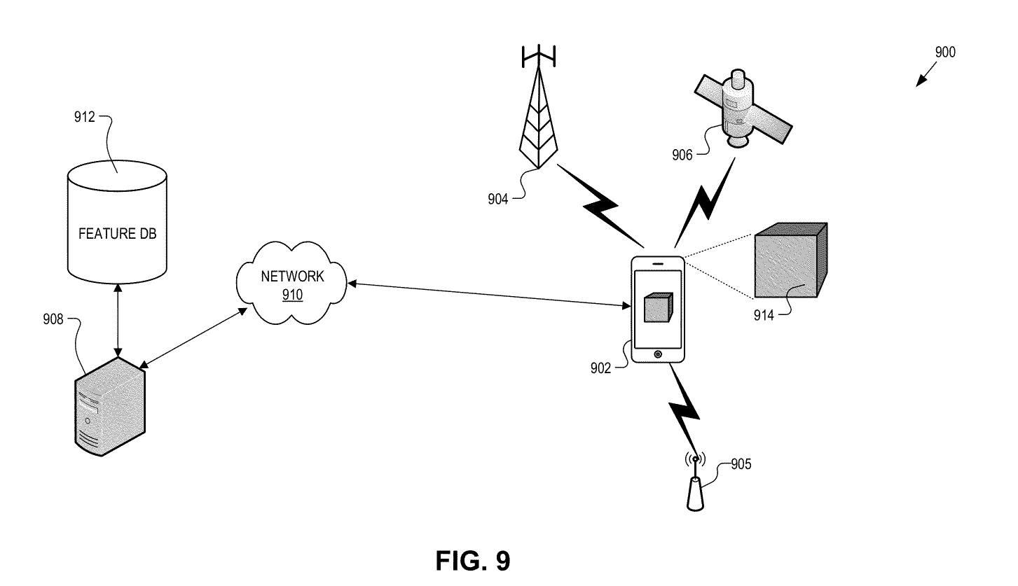

FIG. 9 is a functional block diagram of an object recognition system 900. As shown, object recognition system 900 includes an example mobile platform 902 that includes a camera (not shown in current view) capable of capturing images of an object 914 that is to be identified by comparison to a feature database 912. Feature database 912 may include any of the aforementioned pruned databases, including database 216 of FIG. 2 and database 504 of FIGS. 5, 6, and 8. Feature database 912 includes features having both descriptors and keypoint locations, as discussed above.

The mobile platform 902 may include a display to show images captured by the camera. The mobile platform 902 may also be used for navigation based on, e.g., determining its latitude and longitude using signals from a satellite positioning system (SPS), which includes satellite vehicle(s) 906, or any other appropriate source for determining position including cellular tower(s) 904 or wireless communication access points 905. The mobile platform 902 may also include orientation sensors, such as a digital compass, accelerometers or gyroscopes, that can be used to determine the orientation of the mobile platform 902.

As used herein, a mobile platform refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile platform” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile platform” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. In addition a “mobile platform” may also include all electronic devices which are capable of augmented reality (AR), virtual reality (VR), and/or mixed reality (MR) applications. Any operable combination of the above are also considered a “mobile platform.”

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs) 906. For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile platform 902 is not limited to use with an SPS for position determination, as position determination techniques may be implemented in conjunction with various wireless communication networks, including cellular towers 904 and from wireless communication access points 905, such as a wireless wide area network (WWAN), a wireless local area network (WLAN), a wireless personal area network (WPAN). Further the mobile platform 902 may access one or more servers 908 to obtain data, such as reference images and reference features from a database 912, using various wireless communication networks via cellular towers 904 and from wireless communication access points 905, or using satellite vehicles 906 if desired. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

As shown in FIG. 9, system 900 includes mobile platform 902 capturing an image of object 914 to be identified by comparison to a feature database 912. As illustrated, the mobile platform 902 may access a network 910, such as a wireless wide area network (WWAN), e.g., via cellular tower 904 or wireless communication access point 905, which is coupled to a server 908, which is connected to database 912 that stores information related to target objects and their images. While FIG. 9 shows one server 908, it should be understood that multiple servers may be used, as well as multiple databases 912. Mobile platform 902 may perform the object detection itself, as illustrated in FIG. 9, by obtaining at least a portion of the database 912 from server 908 and storing the downloaded data in a local database inside the mobile platform 902. The portion of a database obtained from server 908 may be based on the mobile platform's geographic location as determined by the mobile platform's positioning system. Moreover, the portion of the database obtained from server 908 may depend upon the particular application that requires the database on the mobile platform 902. The mobile platform 902 may extract features from a captured query image, and match the query features to features that are stored in the local database. The query image may be an image in the preview frame from the camera or an image captured by the camera, or a frame extracted from a video sequence. The object detection may be based, at least in part, on determined confidence levels for each query feature, which can then be used in outlier removal. By downloading a small portion of the database 912 based on the mobile platform's geographic location and performing the object detection on the mobile platform 902, network latency issues may be avoided and the over the air (OTA) bandwidth usage is reduced along with memory requirements on the client (i.e., mobile platform) side. If desired, however, the object detection may be performed by the server 908 (or other server), where either the query image itself or the extracted features from the query image are provided to the server 908 by the mobile platform 902.

The order in which some or all of the process blocks appear in each process discussed above should not be deemed limiting. Rather, one of ordinary skill in the art having the benefit of the present disclosure will understand that some of the process blocks may be executed in a variety of orders not illustrated.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Various modifications to the embodiments disclosed herein will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method of building a database containing a plurality of features corresponding to a 3-dimensional (3D) target object, the method comprising:
acquiring a plurality of images of the target object, wherein each of the plurality of images are acquired from a distinct and known viewpoint of the target object;
extracting a first set of features from the plurality of images, wherein each extracted feature includes a descriptor and a corresponding keypoint location;
selecting a feature from the first set of features; and then,
(a) determining a second set of features corresponding to the selected feature, wherein the second set of features includes features of the first set that have both, a descriptor that matches a descriptor of the selected feature, and a keypoint location proximate to a keypoint location of the selected feature;
(b) determining a repeatability of the selected feature;
(c) determining a discriminability of the selected feature; and
(d) storing at least one derived feature based, at least, on the repeatability of the selected feature, a repeatability threshold, the discriminability of the selected feature, and a discriminability threshold, wherein the at least one derived feature is representative of the second set of features.

2. The computer-implemented method of claim 1, further comprising repeating (a)-(d) for other extracted features included in the first set of features.

3. The computer-implemented method of claim 1, wherein the first set of features includes only those extracted features that have keypoint locations associated with the target object.

4. The computer-implemented method of claim 1, wherein determining the repeatability of the selected feature includes,
determining whether a keypoint location of the selected feature is observable from multiple distinct viewpoints; and if so
determining a number of viewpoints in which the keypoint location of the selected feature is described by a descriptor that matches the descriptor of the selected feature.

5. The computer-implemented method of claim 4, wherein the repeatability is the number of features included in the second set of features.

6. The computer-implemented method of claim 1, wherein determining the discriminability of the selected feature includes,
determining a first number of viewpoints in which a keypoint location of the selected feature is described by a descriptor that matches a descriptor of the selected feature;
determining a second number of features in the first set of features that have descriptors that match the descriptor of the selected feature; and
determining a ratio of first number to the second number.

7. The computer-implemented method of claim 1, wherein the derived feature includes a descriptor that is an average of descriptors included in the second set of features.

8. The computer-implemented method of claim 1, further comprising generating an M number of derived features for the selected feature, wherein the M number of derived features are generated by clustering together features of the second set into M number of clusters.

9. The computer-implemented method of claim 1, further comprising removing the features of the second set from the first set of features in response to an event selected from the group consisting of: adding the at least one derived feature to the database, determining that the repeatability of the selected feature is not greater than the repeatability threshold, and determining that the discriminability of the selected feature is not greater than the discriminability threshold.

10. The computer-implemented method of claim 1, wherein the target object is a first target object and the plurality of images is a first plurality of images, the method further comprising acquiring a second plurality of images of a second target object from several distinct and known viewpoints, wherein extracting the first set of features includes extracting features from both the first and second pluralities of images, such that the database is a multi-object database containing derived features of both the first and second target objects.

11. The computer-implemented method of claim 1, further comprising building a pruned database from the database containing a first set of derived features, wherein building the pruned database comprises:
rendering a plurality of synthetic images of the target object, wherein each of the plurality of synthetic images are rendered using a distinct and known viewpoint;
extracting a third set of features from the plurality of synthetic images;
matching features of the third set to features included in the first set of derived features;
determining a number of times each feature of the first set of derived features is matched to a feature of the third set; and then,
(a) adding a feature of the first set of derived features that has the most matches to the pruned database and removing the feature from the first set of derived features; and
(b) repeating (a) until each viewpoint used to render the plurality of synthetic images includes a threshold number of features added to the pruned database.

12. A computer-readable medium including program code stored thereon for building a database containing a plurality of features corresponding to a 3-dimensional (3D) target object, the program code comprising instructions to:
acquire a plurality of images of the target object, wherein each of the plurality of images are acquired from a distinct and known viewpoint of the target object;
extract a first set of features from the plurality of images, wherein each extracted feature includes a descriptor and a corresponding keypoint location;
select a feature from the first set of features; and then,
(a) determine a second set of features corresponding to the selected feature, wherein the second set of features includes features of the first set that have both, a descriptor that matches a descriptor of the selected feature, and a keypoint location proximate to a keypoint location of the selected feature;
(b) determine a repeatability of the selected feature;
(c) determine a discriminability of the selected feature; and
(d) store at least one derived feature based, at least, on the repeatability of the selected feature, a repeatability threshold, the discriminability of the selected feature, and a discriminability threshold, wherein the at least one derived feature is representative of the second set of features.

13. The computer-readable medium of claim 12, further comprising instructions to repeat (a)-(d) for other extracted features included in the first set of features.

14. The computer-readable medium of claim 12, wherein the first set of features includes only those extracted features that have keypoint locations associated with the target object.

15. The computer-readable medium of claim 12, wherein the instructions to determine the repeatability of the selected feature includes instructions to,
determine whether a keypoint location of the selected feature is observable from multiple distinct viewpoints; and if so
determine a number of viewpoints in which the keypoint location of the selected feature is described by a descriptor that matches the descriptor of the selected feature.

16. The computer-readable medium of claim 12, wherein the instructions to determine the discriminability of the selected feature includes instructions to,
determine a first number of viewpoints in which a keypoint location of the selected feature is described by a descriptor that matches a descriptor of the selected feature;
determine a second number of features in the first set of features that have descriptors that match the descriptor of the selected feature; and
determine a ratio of first number to the second number.

17. The computer-readable medium of claim 12, wherein the derived feature includes a descriptor that is an average of descriptors included in the second set of features.

18. The computer-readable medium of claim 12, further comprising instructions to generate an M number of derived features for the selected feature, wherein the M number of derived features are generated by clustering together features of the second set into M number of clusters.

19. The computer-readable medium of claim 12, further comprising instructions to remove the features of the second set from the first set of features in response to an event selected from the group consisting of: adding the at least one derived feature to the database, determining that the repeatability of the selected feature is not greater than the repeatability threshold, and determining that the discriminability of the selected features is not greater than the discriminability threshold.

20. The computer-readable medium of claim 12, wherein the target object is a first target object and the plurality of images is a first plurality of images, the program code further comprising instructions to acquire a second plurality of images of a second target object from several distinct and known viewpoints, wherein the instructions to extract the first set of features includes instructions to extract features from both the first and second pluralities of images, such that the database is a multi-object database containing derived features of both the first and second target objects.

21. An apparatus, comprising:
memory adapted to store program code for building a database containing a plurality of features corresponding to a 3-dimensional (3D) target object;
a processing unit adapted to access and execute instructions included in the program code, wherein when the instructions are executed by the processing unit, the processing unit directs the apparatus to:
acquire a plurality of images of the target object, wherein each of the plurality of images are acquired from a distinct and known viewpoint of the target object;
extract a first set of features from the plurality of images, wherein each extracted feature includes a descriptor and a corresponding keypoint location;
select a feature from the first set of features; and then,
(a) determine a second set of features corresponding to the selected feature, wherein the second set of features includes features of the first set that have both, a descriptor that matches a descriptor of the selected feature, and a keypoint location proximate to a keypoint location of the selected feature;
(b) determine a repeatability of the selected feature;
(c) determine a discriminability of the selected feature; and
(d) store at least one derived feature based, at least, on the repeatability of the selected feature, a repeatability threshold, the discriminability of the selected feature, and a discriminability threshold, wherein the at least one derived feature is representative of the second set of features.

22. The apparatus of claim 21, wherein the program code further comprises instruction to direct the apparatus to repeat (a)-(d) for other extracted features included in the first set of features.

23. The apparatus of claim 21, wherein the first set of features includes only those extracted features that have keypoint locations associated with the target object.

24. The apparatus of claim 21, wherein the instructions to determine the repeatability of the selected feature includes instructions to,
determine whether a keypoint location of the selected feature is observable from multiple distinct viewpoints; and if so
determine a number of viewpoints in which the keypoint location of the selected feature is described by a descriptor that matches the descriptor of the selected feature.

25. The apparatus of claim 21, wherein the instructions to determine the discriminability of the selected feature includes instructions to,
determine a first number of viewpoints in which a keypoint location of the selected feature is described by a descriptor that matches a descriptor of the selected feature;
determine a second number of features in the first set of features that have descriptors that match the descriptor of the selected feature; and
determine a ratio of first number to the second number.

26. The apparatus of claim 21, wherein the derived feature includes a descriptor that is an average of descriptors included in the second set of features.

27. The apparatus of claim 21, wherein the program code further comprises instructions to direct the apparatus to generate an M number of derived features for the selected feature, wherein the M number of derived features are generated by clustering together features of the second set into M number of clusters.

28. The apparatus of claim 21, wherein the program code further comprises instructions to direct the apparatus to remove the features of the second set from the first set of features in response to an event selected from the group consisting of: adding the at least one derived feature to the database, determining that the repeatability of the selected feature is not greater than the repeatability threshold, and determining that the discriminability of the selected features is not greater than the discriminability threshold.

29. The apparatus of claim 21, wherein the target object is a first target object and the plurality of images is a first plurality of images, the program code further comprising instructions to direct the apparatus to acquire a second plurality of images of a second target object from several distinct and known viewpoints, wherein the instructions to extract the first set of features includes instructions to extract features from both the first and second pluralities of images, such that the database is a multi-object database containing derived features of both the first and second target objects.

30. The apparatus of claim 21, further comprising a camera to acquire the plurality of images of the target object.

31. An apparatus for use in building a database containing a plurality of features corresponding to a 3-dimensional (3D) target object, the apparatus comprising:
means for acquiring a plurality of images of the target object, wherein each of the plurality of images are acquired from a distinct and known viewpoint of the target object;
means for extracting a first set of features from the plurality of images, wherein each extracted feature includes a descriptor and a corresponding keypoint location;
means for selecting a feature from the first set of features; and then,
(a) determining a second set of features corresponding to the selected feature, wherein the second set of features includes features of the first set that have both, a descriptor that matches a descriptor of the selected feature, and a keypoint location proximate to a keypoint location of the selected feature;
(b) determining a repeatability of the selected feature;
(c) determining a discriminability of the selected feature; and
(d) storing at least one derived feature based, at least, on the repeatability of the selected feature, a repeatability threshold, the discriminability of the selected feature, and a discriminability threshold, wherein the at least one derived feature is representative of the second set of features.

32. The apparatus of claim 31, further comprising means for repeating (a)-(d) for other extracted features included in the first set of features.

33. The apparatus of claim 31, wherein the first set of features includes only those extracted features that have keypoint locations associated with the target object.

34. The apparatus of claim 31, wherein the target object is a first target object and the plurality of images is a first plurality of images, the apparatus further comprising means for directing the apparatus to acquire a second plurality of images of a second target object from several distinct and known viewpoints, wherein the means for extracting features includes means for extracting features from both the first and second pluralities of images, such that the database is a multi-object database containing derived features of both the first and second target objects.
